(19) United States
(12) Patent Application Publication
(10) Pub. No.: US 2002/0072920 A1
(43) Pub. Date: Jun. 13, 2002

(54) Computer implemented method of generating information disclosure statements

(76) Inventor: Jeffry Grainger, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/733,616

(22) Filed: Dec. 7, 2000

(51) Int. Cl. G06F 17/24; G06F 17/21; G06F 17/00; G06F 15/00; G06F 17/60

(52) U.S. Cl. 705/1; 707/500

(57) ABSTRACT

A computer implemented method of generating invention disclosure statements. The method of the present invention reduces the likelihood that a known prior art reference document will erroneously go undisclosed to a patent office by an individual associated with the filing and prosecution of a patent applications. Additionally, the method of the present invention simplifies and streamlines the tasks that must be carried out in order to comply with the various disclosure requirements of patent offices around the world. In one embodiment, the computer-implemented method of the present invention includes receiving a signal indicating that a user has identified an electronic document that contains reference information to be disclosed to a patent office, the reference information including information necessary for completing an invention disclosure statement (“IDS information”). The IDS information is stored in an electronic information disclosure statement, which may then be manually or electronically transmitted to a patent office.

### CROSS-REFERENCES TO RELATED APPLICATIONS

This application is related to U.S. application Ser. No. 09/585,947, filed Jun. 2, 2000, entitled “COMPUTER-IMPLEMENTED METHOD FOR SECURING INTELLECTUAL PROPERTY,” and listing Jeffry J. Grainger as inventor. This application is also related to U.S. application Ser. No. 09/585,989, filed Jun. 2, 2000, entitled “COMPUTER-IMPLEMENTED METHOD OF DOCKETING INTELLECTUAL PROPERTY FILINGS,” and listing Jeffrey J. Grainger as inventor. This application is also related to U.S. application Ser. No. 09/642,619, filed Aug. 17, 2000, entitled “COMPUTER-IMPLEMENTED METHOD OF DOCKETING INTELLECTUAL PROPERTY FILINGS,” and listing Jeffry J. Grainger as inventor. The disclosures of Ser. Nos. 09/585,947, 09/585,989, and 09/642,619 are hereby incorporated herein by reference in their entirety. This application is also related to U.S. Provisional Application No. ______ (Attorney Docket No. 19196A-000700US), filed Nov. 27, 2000, entitled “DATA PROCESSING SYSTEM FOR MANAGING INTELLECTUAL PROPERTY,” and listing Jeffry J. Grainger as inventor, which is incorporated herein by reference in its entirety.

### BACKGROUND OF THE INVENTION

The present invention relates to managing intellectual property. More particularly, the present invention relates to a computer-implemented method of automatically generating information disclosure statements associated with obtaining and maintaining intellectual property rights such as patent rights.

As the world economy has become more information and technology oriented, patents and other intellectual property are of growing importance. In order to secure such intellectual property rights appropriate paperwork needs to be completed and filed in an intellectual property office. For example, in order to secure patent protection within the United States, a patent application describing and claiming an invention needs to be filed in the United States Patent and Trademark Office (USPTO). Once filed, previously established rules and guidelines are followed by a Patent Examiner to determine whether or not patent rights to the invention should be granted. For example, in the United States one important rule requires that each individual associated with the filing and prosecution of a patent application has a duty of candor and good faith in dealing with the Patent Office, which includes the duty to disclose to the Office all information known to that individual to be material to patentability. Failure of an applicant to meet this requirement can in some cases lead to the invalidity of any patents that ultimately issues. Additionally, the patent systems of some foreign countries may also have requirements analogous U.S. duty to disclose.

Traditional methods of meeting the disclosure requirements in the USPTO have centered on the preparation and submission of an Information Disclosure Statement (“IDS”). Typically, a patentee or other individual associated with the filing and prosecution of a patent application who is aware of a prior art document that is material to patentability will fill out an IDS and submit the IDS in paper form to the USPTO. However, problems with the management and submission of IDS's often arise when a large number of individuals become associated with the filing and prosecution of a patent application. For example, a single application may involve one or more inventors, one or more in-house patent attorneys and/or patent managers, and one or more external patent attorneys responsible for various portions of the patenting process. As the number of individuals associated with the filing and prosecution of a patent application increases, the risk associated with failing to meet the disclosure requirements also increases.

Another problem associated with the management and submission of IDS's arises in the context of patent applications that are filed internationally. As previously mentioned, other patent systems have rules analogous to the U.S. duty of disclosure. Problems meeting international disclosure requirements can quickly become unmanageable when an organization such as a law firm or an internal patent group of a corporation is attempting to reconcile search reports and/or disclosure materials for a large number of inventions across multiple countries around the world. Further complicating matters, any prior art references cited by foreign patent offices must be disclosed to the USPTO in the corresponding U.S. Patent Application if it remains pending.

Therefore, the contemporary use of paper forms prepared by manual entry of information is inherently filled with risk and potential liability. Accordingly, improved methods of generating information disclosure statements for domestic and international patent filings is desirable.

### SUMMARY OF THE INVENTION

Embodiments of the present invention solve the problems described above with respect to previously known methods of generating information disclosure statements. Specifically, the present invention provides a computer-implemented method of generating invention disclosure statements. The method of the present invention reduces the likelihood that a known prior art reference document will erroneously go undisclosed to a patent office by an individual associated with the filing and prosecution of a patent applications.

In one embodiment, the computer-implemented method of the present invention includes receiving a signal indicating that a user has identified an electronic document that contains reference information to be disclosed to a patent office. The reference information includes IDS information. In response to the signal, the IDS information is associate with an electronic information disclosure statement. According to one embodiment, a plurality of pointers are stored in the electronic information disclosure statement, wherein each pointer corresponds to an electronic document. In another embodiment, the IDS information is stored in the electronic information disclosure statement.

In another embodiment, the present invention includes a computer system having a computer processor and computer readable-memory, coupled to the processor. The computer-readable memory includes computer instructions to receive a signal indicating that a user has identified an electronic document that contains reference information to be disclosed to a patent office. The reference information includes IDS information. The computer instructions also provide for storing the IDS information in an electronic information disclosure statement.

These and other embodiments of the present invention, as well as its advantages and features, are describe in more detail in conjunction with the text below and attached figures.

### BRIEF DESCRIPTION OF THE DRAWINGS

FIG. 1 is a simplified diagram of an example of a hardware system according to one embodiment of the present invention.

FIG. 2 is a flowchart that illustrates a method of generating an electronic IDS according to one embodiment of the present invention.

FIG. 3A shows a web page that includes the results of a patent search to illustrate a method of generating an information disclosure statement according to another embodiment of the present invention.

FIG. 3B shows a patent web page containing reference information corresponding to a patent to illustrate a method of generating an information disclosure statement according to another embodiment of the present invention.

FIG. 4 illustrates a blank invention disclosure statement form typically used to meet the duty of disclosure requirement in the United States Patent and Trademark Office.

FIG. 5 is a flowchart that illustrates a method of generating an electronic IDS that will correspond to the IDS form of FIG. 4.

FIG. 6 is a diagram illustrating one technique for extracting information from a web page into an electronic IDS according to another embodiment of the present invention.

FIG. 7 is a diagram that illustrates incorporating documents from multiple web sites into a single electronic IDS according to another embodiment of the present invention.

FIG. 8 is a simplified diagram of an example of a hardware system according to another embodiment of the present invention.

FIG. 9 is a simplified diagram of an example of a hardware system according to another embodiment of the present invention.

FIG. 10 is a simplified diagram of an example of a hardware system according to another embodiment of the present invention.

### DESCRIPTION OF THE SPECIFIC EMBODIMENTS

The present invention provides a computer-implemented method of generating information disclosure statements (“IDS”) associated with meeting the disclosure requirements for patent applications in a patent office. For convenience, the invention is described below with respect to generating information disclosure statements to be submitted to the United States Patent and Trademark Office (“USPTO”). It is to be understood, however, that the present invention is useful for generating information disclosure statements necessary for meeting disclosure requirements of official patent office in other countries.

As used herein, an “official patent office” is any patent office designated to receive patent filings for an individual country or collection of countries as provided for by various treaties or other compacts that countries may enter. Examples of official patent offices include but are not limited to the United States Patent and Trademark Office, the European Patent Office, the German Patent Office, the Japanese Patent Office and any designated receiving office for patent applications filed under the Patent Cooperation Treaty. The IDS generation technique provided by the method of the present invention is useful for automatically generating the requisite documents required to meet the various disclosure requirements of any particular official patent office around the world.

The computer-implemented method of generating invention disclosure statements according to the present invention enables users to search through a vast amount of potentially relevant prior art information accessible on a large network of computers, such as the internet, and identify relevant electronic documents for disclosure to a patent office. As used herein, the term electronic document refers at least to web pages or other computer files which are remotely accessible. Electronic documents may include U.S. Patent information, foreign patent information, publication information, or other information falling within a disclosure rule for a patent office, for example. Additionally, information included in such electronic documents is referred to herein as reference information.

Once a user has identified a relevant electronic document, embodiments of the present invention automatically extract relevant portions of the reference information from the electronic document into an electronic information disclosure statement (“electronic IDS”). The portion of the reference information relevant to an electronic IDS is referred to herein as IDS information. It is to be understood that the reference information in an electronic document may include some or all of the information necessary for including a particular prior art reference in an electronic IDS for disclosure to a patent office. IDS information as defined herein includes whatever portion of the reference information that is relevant to completing an invention disclosure to a patent office. Moreover, an electronic IDS may be an electronic file for storing IDS information extracted from an electronic document. Additionally, an electronic IDS, as referred to herein, may also be a electronic file storing a plurality of pointers. Each pointer may correspond to a relevant local or remote electronic document containing IDS information that must be submitted to an official patent office. Alternatively, in one embodiment, the electronic IDS is a electronic file for storing each relevant electronic document that must be submitted to an official patent office. In that case, the IDS information is filtered from the electronic IDS when the final Information Disclosure Statement is submitted. In yet another embodiment, the reference information or the entire electronic documents are stored in a database, and the electronic IDS is a file corresponding to a particular patent application that includes cross-references to particular documents stored in the database.

After the IDS information has been incorporated into the electronic IDS, the electronic IDS can then be transmitted manually or electronically to the pertinent official patent office. The electronic IDS can be stored on a particular user's computer, on a local server, or on a remote server. Accordingly, embodiments of the present invention drastically simplify the process of generating information disclosure statements, thereby reducing the likelihood that a person associated with the filing or prosecution of a patent application will fail to meet the duty of disclosure.

Additionally, embodiments of the present invention provide patent applicants with an easy way of searching for prior art and providing the prior art to an official patent office in an effort to increase the value of the patent that ultimately issues. Furthermore, other embodiments provide technologists with a way of searching a technical field for information and storing information that may be relevant to a future patent application into an electronic IDS. Moreover, in another embodiment, patent applicants or inventors may be provided with instructions on when a particular electronic document falls within the duty of disclosure, and therefore should be added to an electronic IDS.

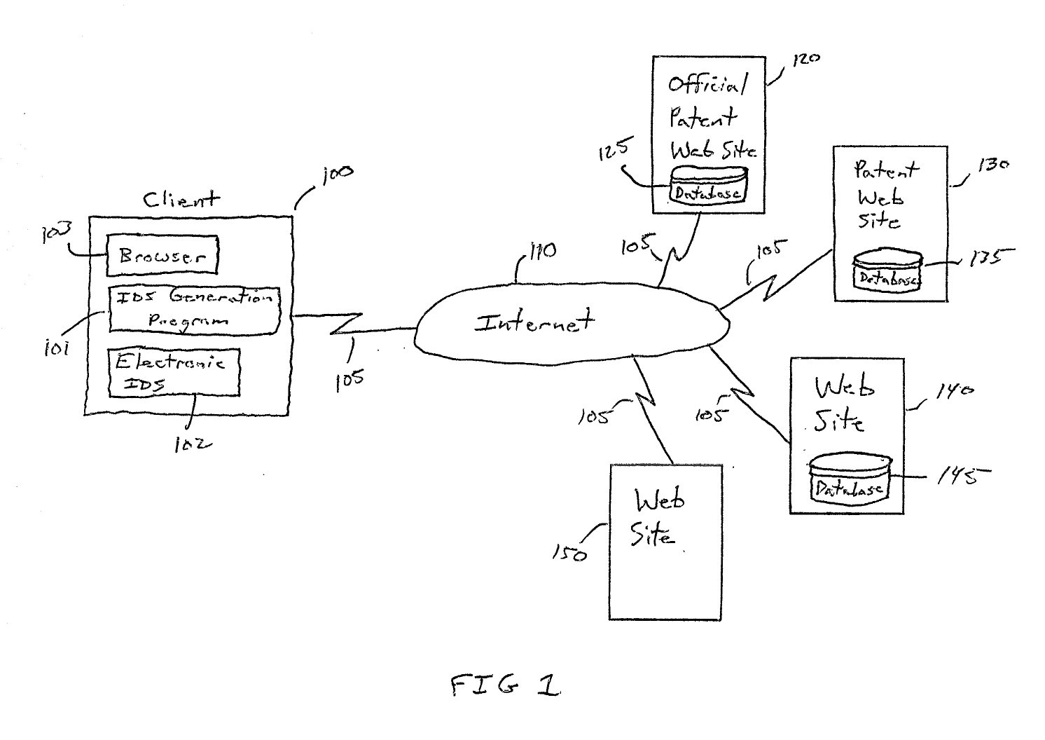

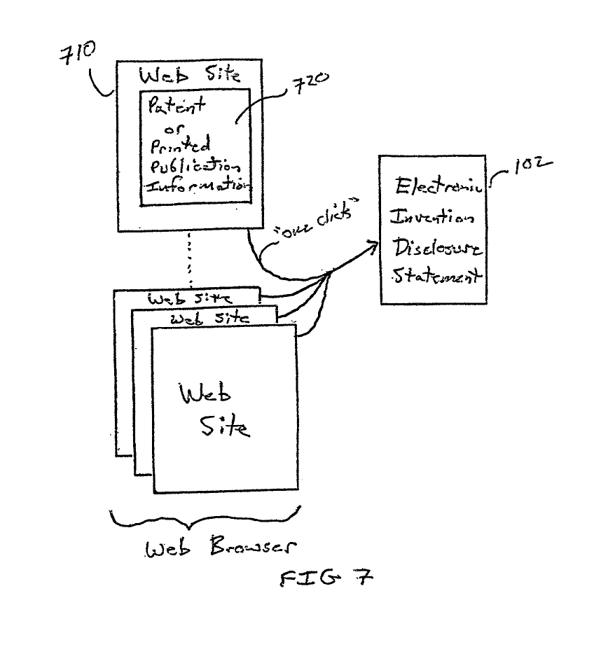

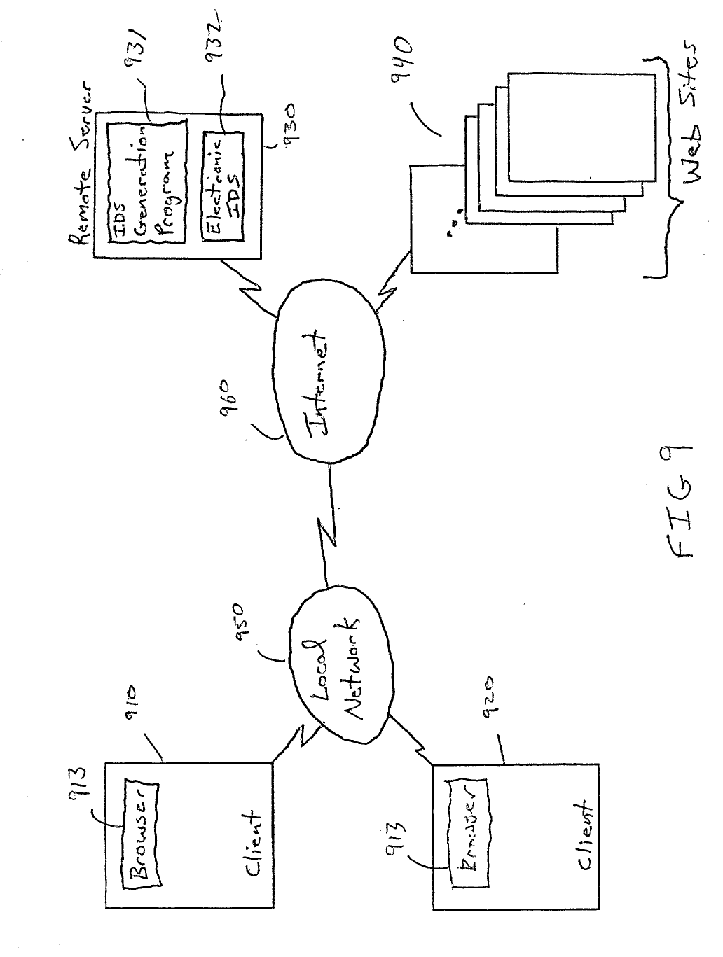

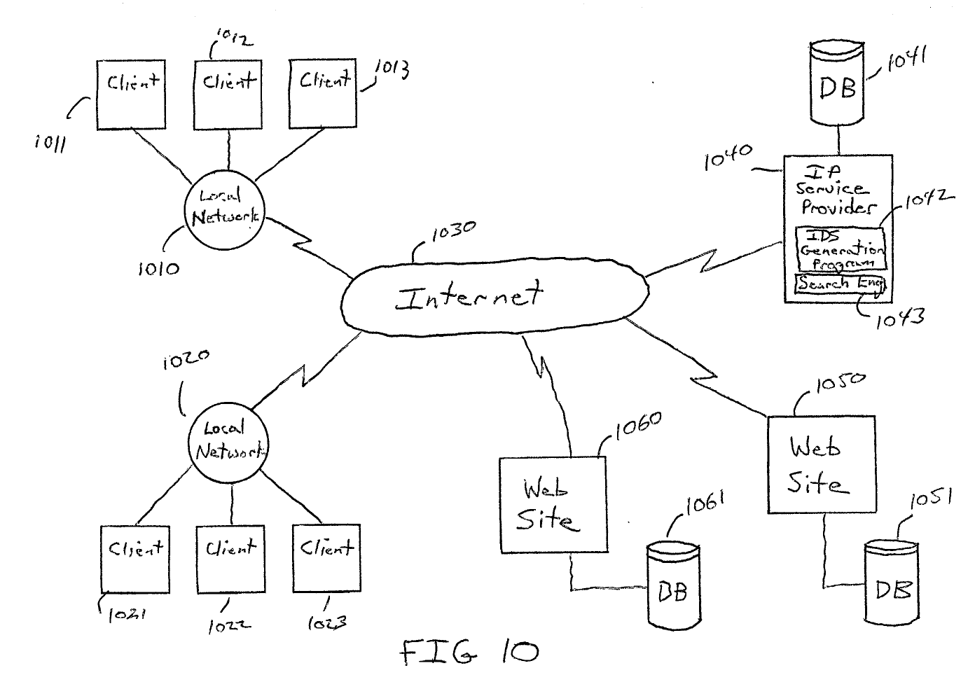

Among other techniques, embodiments of the present invention may be implemented by providing program code operating on a computer system that is connected to the internet as described below with respect to FIG. 1. In another embodiment, program code is included on multiple computer systems that are connected together and to a local database over a local network. The local network is then connected to the internet as illustrated FIG. 7. In another embodiment, the program code operates on a remote server as described below with respect to FIG. 9. In yet another embodiment, multiple local networks access a remote intellectual property (“IP”) service provider that includes program code for searching web sites for information and for automatically generating electronic IDS's as illustrated in FIG. 10.

FIG. 1 is a simplified, system-level diagram of an example of a hardware configuration that can be used to implement a first embodiment of the present invention. FIG. 1 includes a local client computer system 100 to be used by a user. The client system 100 is connected to the internet 110 over a communication link 105. The client system may also be connected to remote web sites 120, 130, 140, and 150 via the internet 10 and additional communication links 105. It is to be understood that the client computer systems, server computer systems, and the computer systems of the remote web sites typically include a computer processor and computer readable memory, coupled to said processor, (not shown) for storing programs and other software as is well know in the art.

Client system 100 includes an IDS generation program 101. IDS generation program 101 is used, for example, to create or update an electronic IDS 102 at the request of a user. Client system 100 also includes browser software 103. Browser software 103 may be either Netscape or Internet Explorer browsers, for example. Browser software 103 allows a user to access web sites 120, 130, 140, and 150. For example, in one embodiment a user may be an inventor with a new idea that he believes may be worth patenting. The user can activate IDS generation program 101, which may generate a new electronic IDS corresponding to a potential patent application. Next, the user can activate the browser 103 and search the internet for prior art documents. In another embodiment, the browser is integrated into the IDS generation program. Accordingly, when a user activates the IDS generation program, integrated browser capabilities allow the user to search the internet for prior art information.

Referring to FIG. 1, the user can activate browser 103 to access an official patent web site 120 over the internet 110. An official patent web site may be the official web site of an official patent office such as the USPTO, the European Patent Office, or the Japanese Patent Office. The user may then use browser 103 to search through a database 125 located on the official patent web site 120 for issued patents, published patents, or relevant publications.

Additionally, the user can activate browser 103 to access a patent web site 130 over the internet 110. A patent web site may be a privately operated web site containing a database 135 of patent related materials (e.g. such as MicroPatent or the Delphion Intellectual Property Network). The user may then use browser 103 to search through a database 135 located on the patent web site 130 for issued patents, published patents, or relevant publications.

Moreover, the user can connect to other web sites 140 over the internet 110 that contain databases 145 of general information that may include issued patents, published patents, technical publications, articles, or internet publications relevant to a future or pending patent application. These may be fee services such as LEXIS, DIALOG, or WESTLAW, or alternatively, free services such as “search.stanford.edu” or other remotely accessible databases containing free potential prior art information. The user may then use browser 103 to search through a database 145 located on the web site 140 for any relevant publications the need to be disclosed to a patent office.

Furthermore, FIG. 1 illustrates that a user can search a web site 150 over the internet for any information that may be relevant to a future or pending patent application.

For example, if the user is planning on filing, or has already filed, a patent application relating to a method of providing an on-line auction, the user may search internet web sites for existing on-line auction web sites. The user can then disclose prior art on-line auction web sites that may be relevant to the future or pending patent application by disclosing to the examiner the name, web address, and relevant web pages of the prior art sites.

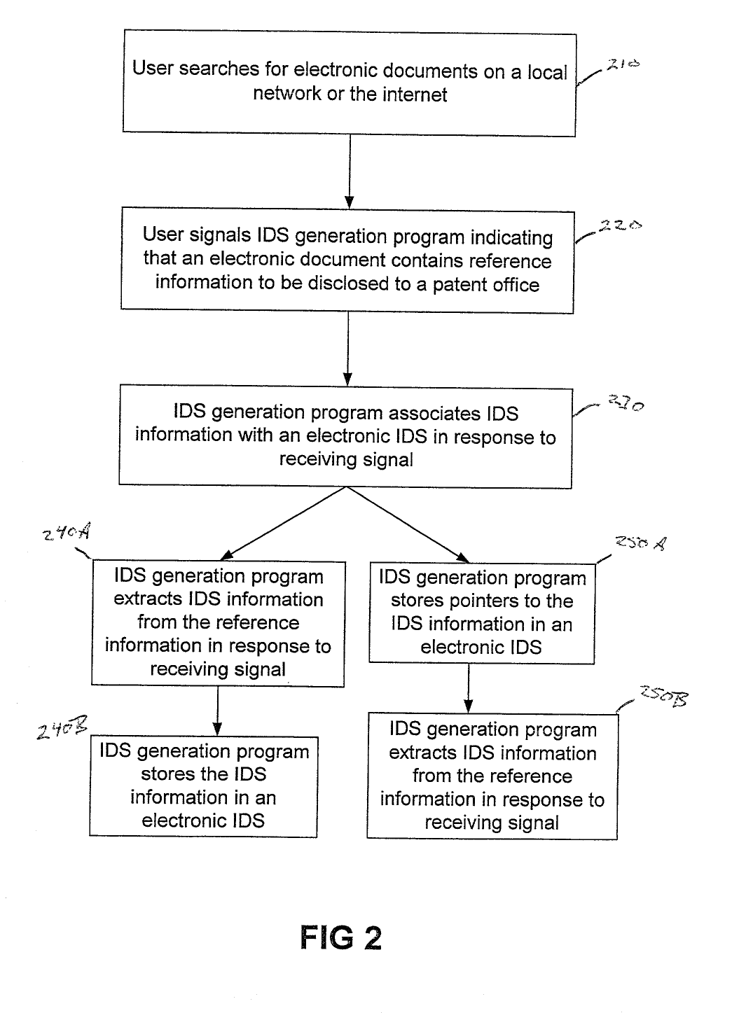

FIG. 2 is a flowchart that illustrates a method of generating an electronic IDS according to one embodiment of the present invention. At step 210, a user searches for electronic documents on a local network or on a remote network such as the internet. Referring to FIG. 1, a user could search for electronic documents on various web sites 120, 130, 140, or 150 from client system 100 over internet 110. In one embodiment, the user searches various web sites using browser 103, and IDS generation program 101 is running in parallel with the browser. In another embodiment, IDS generation program is included as part of a larger remotely operating IP service provider web site, as described in more detail below. The IP service provider web site may include an IDS generation program and a search engine that are fully integrated into the site, and allow a user to search databases connected to the IP service provider web site as well as other databases connected to the internet.

At step 220, the user signals an IDS generation program indicating that an electronic document has been found that contains reference information to be disclosed to a patent office. For example, the reference information could be in an electronic patent document or electronic version of a printed publication. The IDS generation program provides a prompt to the user for generating a signal to the IDS generation program when the user has identified an electronic document to be disclosed to a patent office. In one embodiment, the prompt is provided by modifying the right-click mouse pop-up window to include an additional field. An additional field in the pop-up menu may display “save as IDS”. When the user has identified a relevant electronic document, the user may activate the pop-up window and select “save as IDS.” Selecting this menu option will signal the IDS generation program that the user has identified a relevant document that is to be disclosed to a patent office. The signal may cause the current document in the browser to be included in the electronic IDS, for example. In another embodiment, the prompt is an electronic button on the users computer screen. When a user identifies an electronic document to be disclosed to a patent office, the user may simply click the electronic button to signal IDS generation program to include the electronic document in an electronic IDS. Additionally, in another embodiment, the prompt is a computer screen icon. When a user identifies an electronic document to be disclosed to a patent office, the user may simply click the icon to access the IDS generation program. In one embodiment, the user may simply click-and-drag a hypertext link corresponding to an electronic document to either the electronic button or the computer screen icon to cause the electronic document to be included in an electronic IDS.

In one embodiment, the IDS generation program is included as part of a larger remotely operating IP service provider web site. An electronic button is provided as part of the IP service provider web site so that when a user identifies a document to be disclosed to a patent office, the user simply mouse clicks the electronic button to signal the IDS generation program that an electronic document containing reference information to be disclosed to a patent office has been identified.

At step 230, IDS generation program associates IDS information with an electronic IDS in response to receiving the users signal at step 230. FIG. 2 illustrates two exemplary methods that may be used to associate the IDS information with an electronic IDS. According to one embodiment, at 240A the IDS generation program extracts the IDS information from the reference information in response to receiving the signal. Then at step 240B the IDS generation program stores the IDS information in an electronic IDS. In another embodiment, at 250A the IDS generation program stores a plurality of pointers to the IDS information in an electronic IDS. Then at step 250B, the IDS generation program extracts IDS information from the reference information in the electronic document referenced by the pointer in response to receiving a later received signal. For example, the user may search the internet and each time a relevant reference is identified, a pointer to the reference may be stored into the electronic IDS by pressing an electronic button or menu option. Then, when the user is ready to file the electronic IDS in the patent office, the user signals the IDS program to carry out the filing. In response to the filing signal, the IDS generation program extracts the IDS information from the reference information in each electronic document referenced by a pointer in the electronic IDS. The IDS information is automatically compiled and transmitted to a patent office. Alternatively, if electronic submission is unavailable, the signal may indicate that the user desires to print out the IDS information.

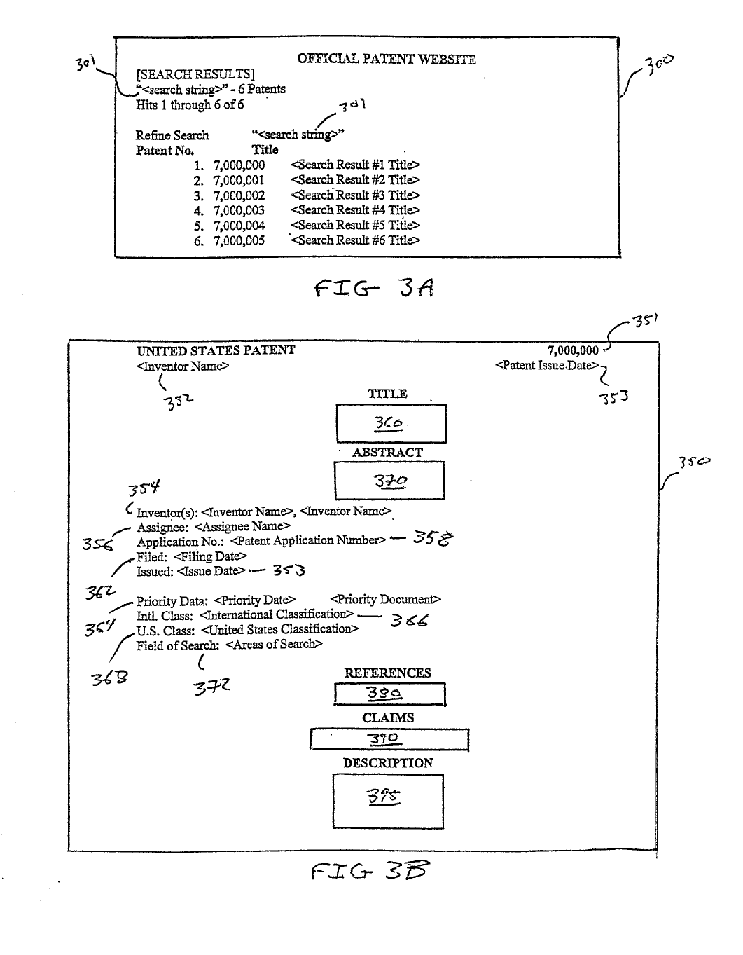

The embodiment of FIG. 2 is further illustrated by FIG. 3A. FIG. 3A illustrates a web page that shows the results of an exemplary patent search carried out at step 210 of FIG. 2 on an official patent web site 120. Search results 300 are in response to a search string 301. For the example shown in FIG. 3A, six patents were found in database 125 of web site 120 in response to a search string 301. Typically, the six patent numbers and/or titles will be in the form of hypertext links as is well known in the art. A user can point a mouse controlled pointer over either the patent number (i.e. U.S. Pat. Nos. 7,000,000 through 7,000,005) or the titles <Search Result #1-6 Title> and click the mouse to access another web page with more information about the particular patent.

FIG. 3B illustrates a patent web page 350 that shows the electronic document containing the reference information corresponding to U.S. Pat. No. 7,000,000 of FIG. 3A. In response to accessing one of the patents identified in the search result, an electronic document containing the patent reference information is downloaded to the user's computer system. The reference information in FIG. 3B includes the patent number 351, the first named inventor 352, the patent issue date 353, the title 360, the abstract 370, the complete list of inventors 354, the name of the assignee 356, the application number 358, the filing date 362, priority data 364, the international classification 366, the United States classification 368, the field of search 372, cited references 380, claims 390, and the description 395. Of course, other databases and/or search engines may provide a subset or superset of the above information corresponding to an issued patent. Additionally, published applications may also be found as a result of searches on official patent web sites 120 or patent web sites 130. Moreover, with the recent changes in U.S. Patent policy, published applications that have not yet issued as patents may contain a subset or superset of the above information and may be available on the USPTO web site in the future. Accordingly, FIGS. 3A and 3B are illustrative only.

It is important to point out that the above reference information made available as a result of a search on a web site may contain more information than is necessary for an electronic IDS. For the example illustrated in FIG. 3B, after identifying and downloading an issued patent that requires disclosure to a patent office, a user may signal IDS generation program to extract only that portion of the reference information necessary for completing an IDS. The program will then store the IDS information in the electronic IDS.

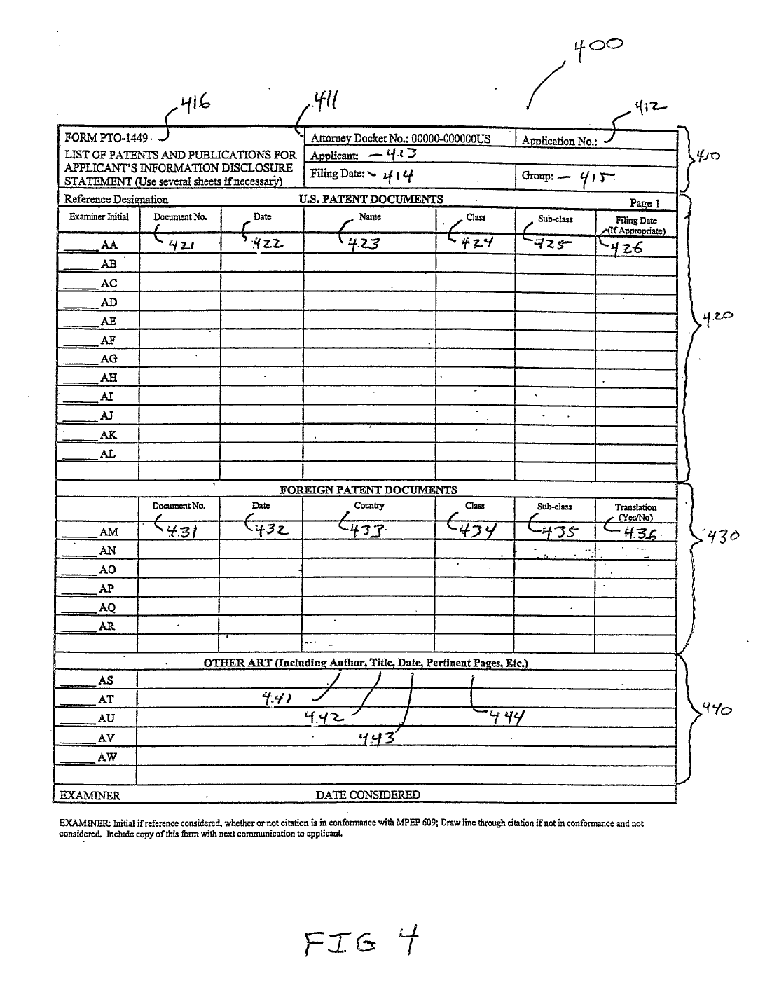

FIG. 4 illustrates a blank invention disclosure statement form (“IDS form”) 400 typically used to meet the duty of disclosure requirement in the USPTO. In accordance with one embodiment of the present invention, an electronic IDS 102 that includes all the information required in this form can be generated by IDS generation program 101. As illustrated by FIG. 4, an IDS form 400 generally includes four sections: a general information section 410, a United States Patent Documents section 420, a Foreign Patent Documents section 430, and a section for publications and articles entitled Other Art 440.

In one embodiment of the present invention, an electronic IDS is a computer file stored on a computer readable medium. The electronic IDS may include information corresponding to the general information section 410 of IDS form 400. The electronic IDS may include an attorney docket number corresponding to IDS form attorney docket number 411, application number corresponding to IDS form application number 412, applicant name corresponding to IDS form applicant 413, filing date corresponding to IDS form filing date 414, group information corresponding to IDS form group 415, and document identification information corresponding to IDS form title 416.

Additionally, an electronic IDS may include information corresponding to U.S. Patent Documents section 420 of IDS form 400 of FIG. 4. An electronic IDS may include information corresponding to IDS form Document No. 421 (i.e. patent number), Date 422 (i.e. date of issuance), Name 423 (i.e. inventor name), Class 424 (i.e. technology classification), sub-class 425, and filing date 426. Moreover, an electronic IDS may include information corresponding to Foreign Patent Documents section 430 of IDS form 400. An electronic IDS may include information corresponding to IDS form Document No. 431, Date 432, Name 433, Class 434, Sub-class 435, and translation 436. Finally, an electronic IDS may include information corresponding to printed publications and other art section 440 of IDS form 400. An electronic IDS may include information corresponding to Author 441, Title 442, Date 443, and Pertinent Pages 444.

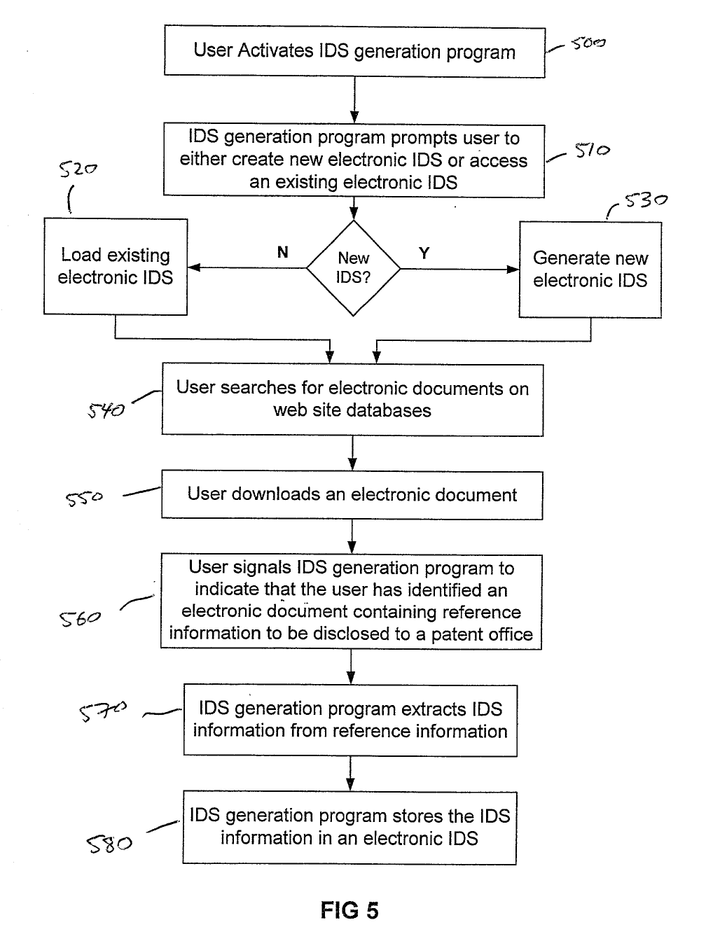

FIG. 5 is a flowchart that illustrates a method of generating an electronic IDS that will correspond to the IDS form 400 of FIG. 4. In step 500, a user activates the IDS generation program 101. The IDS generation program 101 is then loaded from a memory such as a hard disk drive (not shown) on the client system 100 and begins to run. After the IDS program 101 is loaded, it prompts the user to either create a new electronic IDS or access an existing electronic IDS at step 510. Of course, various methods for prompting the user are well known in the art and may include a menu system or pop up window, for example.

If the user accesses a existing electronic IDS, then the existing electronic IDS is loaded from memory at step 520. Step 520 may also include a prompt to the user to enter information identifying a particular electronic IDS to access. For example, the user may be asked to input either a reference number (e.g. an attorney docket number), title, or patent application number to identify the electronic IDS to be accessed. An additional step may be included in other embodiments that provide for the IDS generation program 101 to include program code which requires the user to enter identification information before being allowed access to an existing electronic IDS. Such security features may be useful to guarantee that only individuals associated with the filing and prosecution of a particular patent application will be allowed to modify an existing electronic IDS.

Alternatively, in other embodiments, a user of a IP services web site may access a case file for a patent application. The case file may include links to documents related to the particular patent application. Accordingly, a user may access an existing IDS by simply accessing a link in the case file. Alternatively, a user may create a new IDS for the case file by signaling the desire to create a new IDS, and the resulting new IDS is automatically associated with the particular case file.

On the other hand, if the user indicates that there is no currently existing electronic IDS, then at step 530 the IDS generation program generates a new electronic IDS. According to one embodiment, the IDS generation program prompts the user to input a reference to identification information for a currently existing invention recorded in a database. For example, the IDS generation program may prompt the user to enter or select a reference number, title, or patent application number corresponding to an electronic record of an existing invention stored in a database. The electronic record may already contain the general information corresponding to section 410 of IDS form 400. After the user enters reference, such as the docket number or title, the IDS generation program then accesses the corresponding electronic record of the existing invention and copies the general information into a new electronic IDS. In accordance with general information section 410, IDS program 101 may automatically generate a new electronic IDS file and enter information corresponding to attorney docket number 411, application number 412, applicant 413, filing date 414, and group 415 of IDS form 400.

In another embodiment, when a new electronic IDS is to be created by IDS generation program 101 at step 530, the program prompts the user for the general information corresponding to general information section 410. In accordance with general information section 410, IDS program 101 may prompt the user to enter information corresponding to attorney docket number 411, application number 412, applicant 413, filing date 414, and group 415 of IDS form 400, for example. After a user has entered each piece of general information, IDS program 101 would then generate a new electronic IDS which would include such information.

Storing general information in an electronic IDS would be particularly useful in applications where a new electronic IDS was generated by a first user, for example an inventor, and then accessed later by other users such as the inventors technical manager, an in-house patent attorney, or an external patent attorney. Each user could access a particular electronic IDS by referencing one or more of the pieces of general information stored in each electronic IDS. Furthermore, such information is useful when printing and mailing or otherwise transmitting the electronic IDS to the USPTO.

At step 540 of FIG. 5, a user searches web sites on either a local network or a wide area network, such as the internet, for electronic documents to be disclosed to a patent office. For example, referring again to FIG. 1, a user may access an official patent web site 120 such as the Official United States Patent and Trademark Web Site and search through a database 125 of issued patents and/or patent publications. Alternatively, a user could search through web sites 130, 140, or 150 depending on the technology and/or the type or prior art that the user is interested in finding.

As the user accesses electronic patent documents, electronic publications, or other electronic information on the various web sites, reference information may be downloaded as the browser 103 accesses successive web pages. This is illustrated at step 550. At step 550, the user downloads an electronic document corresponding to accessing a web page containing an electronic version of a patent, electronic version of a published patent application, or electronic version of a publication or article.

When a user has identified an electronic document on a local network or on the internet containing reference information to be disclosed to a patent office, the user may signal IDS generation program 101 at step 560. The signal may be a mouse-click, pressing the enter key of a keyboard, or any other signal for indicating to a computer system on which IDS generation program 101 is running that a relevant document has been identified. Next, at step 570, IDS generation program extracts IDS information from the reference information in response to receiving the signal. Extraction of IDS information can be done by matching fields required for the IDS with appropriate information in the electronic document, which could be readily programmed by one skilled in the art. Finally, at step 580, the IDS generation program stores IDS information in an electronic IDS 102.

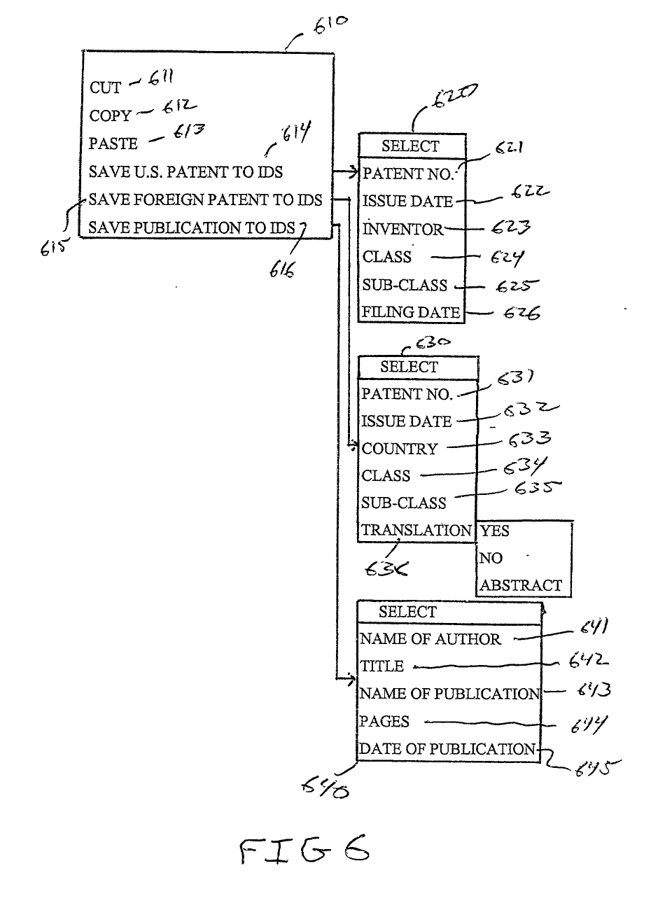

FIG. 6 illustrates another embodiment of the present invention that provides another technique for extracting the relevant information from a web page into an electronic IDS. According to the embodiment shown in FIG. 6, when a user locates an electronic document with relevant reference information to be disclosed to a patent office, patent web page 350 of FIG. 3B for example, the user may right-click the mouse to facilitate the extraction of the necessary information for the electronic IDS 102. As illustrated in FIG. 6, a standard right mouse click pop-up menu 610, which typically includes CUT 611, COPY 612, and PASTE 613, has been modified by IDS generation program to further include SAVE U.S. PATENT TO IDS 614, SAVE FOREIGN PATENT TO IDS 615, and SAVE PUBLICATION TO IDS 616. A user could then select the menu option corresponding to the type of document to be entered into the electronic IDS 102.

For example, if a user selects SAVE U.S. PATENT TO IDS 614, IDS generation program 101 will then prompt the user to identify the different pieces of information to be entered into the electronic IDS 102 that correspond to the required portions of U.S. Patent Document section 220 of IDS form 200. FIG. 6 illustrates that pop up menu 620 is provided to prompt user for each of the required pieces of information. The user then uses the mouse to select the portions of the patent web page 350 that correspond to each piece of required information. For example, the user may first select the patent number with the mouse and then click on the PATENT NO. 621 pop up menu option, and the IDS generation program can enter the selected patent number into the electronic IDS 102. Next, the user may select the issue date on the patent web page 350 with the mouse and then click on the ISSUE DATE 622 pop up menu option. The IDS generation program can then enter the selected issue date into the electronic IDS 102. Likewise, the user may sequentially select inventor name, the U.S. classification, sub-class, and filing date on patent web page 350, and the information will be entered into the electronic IDS 102 by correspondingly selecting INVENTOR 623, CLASS 624, SUB-CLASS 625, and FILING DATE 626.

On the other hand, if a user has located a foreign patent on a foreign patent web page (not shown), the user may select SAVE FOREIGN PATENT TO IDS 615. IDS generation program 101 will then prompt user to identify the different pieces of information to be entered into the electronic IDS 102 that correspond to the required portions of Foreign Patent Document section 230 of IDS form 200 of FIG. 2. FIG. 6 illustrates that pop up menu 630 is provided to prompt user for each of the required pieces of information. The information that must be extracted from a foreign patent is illustrated in FIG. 2 section 230 as the foreign patent number 231, foreign patent issue date 232, country 233, classification 234, sub-class 235, and translation (Y/N) 236. The user then uses the mouse to select the portions of the foreign patent web page (not shown) that correspond to each piece of required information. For example, the user may first select the foreign patent number with the mouse and then click on the PATENT NO. 631 pop up menu option, and the IDS generation program can enter the selected foreign patent number into the electronic IDS 102. Next, the user may select the foreign patent issue date on the foreign patent web page with the mouse and then click on the ISSUE DATE 632 pop up menu option. The IDS generation program can then enter the selected foreign patent issue date into the electronic IDS 102. Likewise, the user may sequentially select the country, the classification, and sub-class on foreign patent web page, and the information will be entered into the electronic IDS 102 by correspondingly selecting COUNTRY 633, CLASS 634, and SUB-CLASS 635. Finally, the user can indicate if a translation is available by selecting TRANSLATION 636 and YES, NO, or ABSTRACT. It should be noted that in some cases the foreign patent document may be a published patent application, in which case the ISSUE DATE 632 may be substituted for PUBLICATION DATE or just DATE.

If a user has located a relevant publication on a publication web page (not shown), the user selects SAVE PUBLICATION TO IDS 616. IDS generation program 101 will then prompt user to identify the different pieces of information to be entered into the electronic IDS 102 which correspond to the required portions of the section for publications and articles entitled Other Art 240 of IDS form 200 of FIG. 2. FIG. 6 illustrates that pop up menu 640 is provided to prompt user for each of the required pieces of information. The information that must be extracted from a publication is illustrated in FIG. 2 section 240 as the Name of Author 241, Title of Publication 242, Name of Publication 243, Pages 244, and Date of Publication (not shown). The user then uses the mouse to select the portions of the publication web page (not shown) that correspond to each piece of required information. For example, the user may first select the name of the author with the mouse and then click on the NAME OF AUTHOR 641 pop up menu option, and the IDS generation program can enter the selected name of the author into the electronic IDS 102. Next, the user may select the title of the article or publication on the publication page with the mouse and then click on the TITLE 642 pop up menu option. The IDS generation program can then enter the selected title into the electronic IDS 102. Likewise, the user may sequentially select the name of the magazine or publication, the relevant pages, and date of the publication, and the information will be entered into the electronic IDS 102 by correspondingly selecting NAME OF PUBLICATION 643, PAGES 644, and DATE OF PUBLICATION 626.

It should be noted that the embodiment of FIG. 6 is just one example of how an IDS generation program may extract the necessary IDS information from a electronic document having relevant reference information into an electronic IDS 102. Of course, other methods for extracting data from a web page could be utilized. In another embodiment, a user may click-and-drag one of the search results 300 of FIG. 3 into an electronic IDS. For that embodiment, an IDS generation program may include code for accessing an electronic document corresponding to each hypertext link associated with each patent result. For example, in response to clicking-and-dragging a particular search result hypertext link in search results page 300, the IDS generation program may automatically access the patent web page 350 for the selected patent. The IDS generation program may then automatically parse the reference information and download only the IDS information from the patent web page 350. The IDS information could then be automatically stored in an electronic IDS.

In another embodiment, when a user identifies a web site with a relevant document, the user may simply mouse click on an electronic button or menu option generated by the IDS generation program. In response to such a single mouse click, the IDS generation program may include code for automatically parsing the active web page and extracting the information necessary for completing the electronic IDS.

In yet another embodiment, the patent web pages 350 are divided into predetermined fields. Each field holds a particular predefined piece of information such as the title, patent number, or inventor name, for example. In such an embodiment, an IDS generation program automatically recognizes the fields and extracts the necessary IDS information by accessing each of the fields where the IDS information is located.

FIG. 7 illustrates accessing a first web site 710 and identifying an electronic document containing 720 patent or printed publication reference information that a user desires to disclose to a patent office. According to one embodiment, FIG. 7 illustrates that with just one click of the mouse the information necessary for completing the electronic IDS 102 is automatically extracted from the patent or printed publication reference information and entered into the electronic IDS 102. FIG. 7 also illustrates how multiple web sites can be accessed with the browser and how reference information from multiple electronic documents can be incorporated into the electronic IDS 102 with just a single mouse click for each electronic IDS entry. Therefore, embodiments of the present invention provide for a simplified method of generating invention disclosure statements. Accordingly, individuals under a duty of disclosure are more likely to comply with the disclosure requirements. This is in part because of the time is saved by utilizing embodiments of the present invention. A user is no longer required to obtain printed copies of every patent that must be filed in order to get the information necessary to fill out an IDS form 400. Moreover, the time and resource consumption associated with manually filling out an IDS form 400 is eliminated. Additionally, the potential liability for accidentally failing to include a reference while preparing an IDS form 400 is also eliminated.

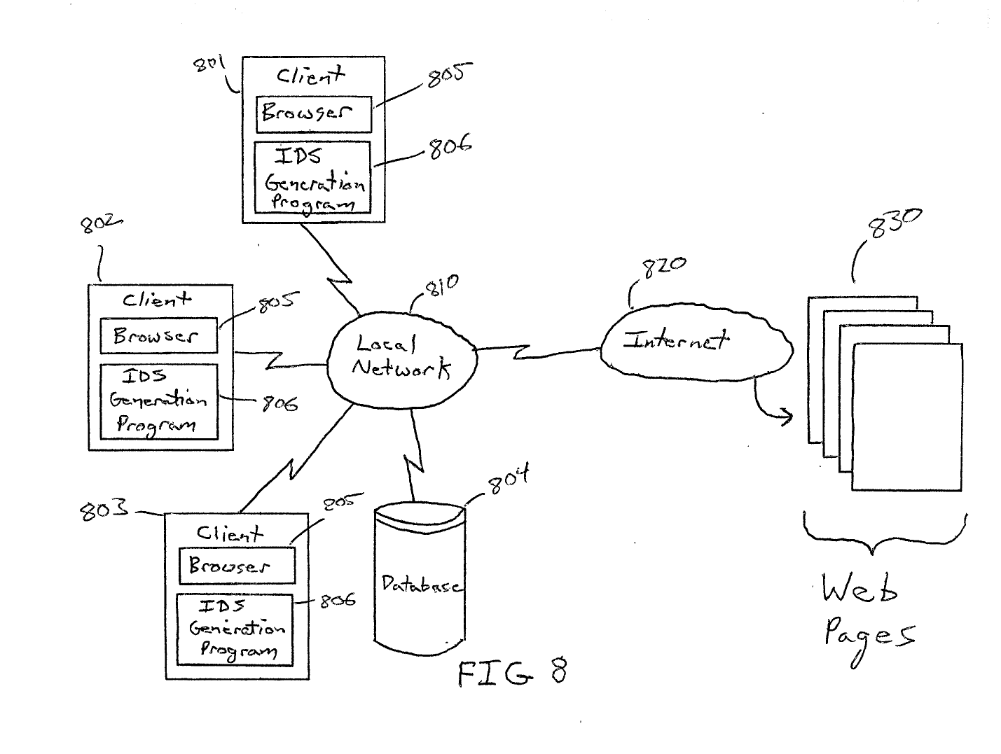

FIG. 8 is a simplified diagram of an example of a hardware system according to another embodiment of the present invention. FIG. 8 shows a group of client systems 801, 802, and 803 that are connected together and to a local database 804 by a local network 810. Database 804 may store multiple electronic IDS corresponding to multiple inventions, for example. The local network is connected to the internet 820 for accessing remote web sites 830. FIG. 8 illustrates that in another embodiment of the present invention the IDS generation program 805 may reside on multiple clients 801-804. Therefore, according to the embodiment of FIG. 8, multiple client systems 801, 802, and 803 could each access an electronic IDS stored in database 804. For example, client systems 801-804 may each include a local browser 805 and IDS generation program 806 for accessing web pages on the internet and storing IDS information into an electronic IDS stored in database 804. Additionally, each client system would be able to access all of the electronic IDS stored in database 804. This embodiment is particularly suited for applications where multiple users will be generating and accessing the same electronic IDS for a single pending or future patent application.

As mentioned earlier, one embodiment of IDS generation program 806 may include program code for controlling the user access rights for each electronic IDS. Such code may require the user to enter an access code or password before being allowed access to an existing electronic IDS. For example, the access to each electronic IDS may be limited to individuals falling under the duty of disclosure for the corresponding future or pending patent application. Therefore, an IDS generation program may prompt a user for an access code when a user requests access to an electronic IDS. If the user provides the correct code, then the IDS generation program may allow the user to access the electronic IDS. However, if the user provides an incorrect code, the IDS generation program may not allow the user to access the electronic IDS. This feature would be particularly useful for ensuring that only individuals associated with the filing and prosecution of a particular patent application will have the ability to update or modify an electronic IDS corresponding to a particular patent application.

FIG. 9 is a simplified diagram of an example of a hardware system according to another embodiment of the present invention. FIG. 9 includes client systems 910 and 920 connected together over a local network 950 and to a remote server 930 over internet 960. Client systems 910 and 920 each includes a browser 913 that can be used to access the remote server 930 web site. The IDS generation program 931 can then be accessed allowing a user to remotely generate and modify new or existing electronic IDS 932. One advantage of this embodiment is that multiple users may search web sites 940 over the internet 960 for electronic documents that can be incorporated into the electronic IDS 932.

The embodiment of FIG. 9 utilizing a remote server 930 is particularly useful for applications where users in multiple locations need to access and generate the same electronic IDS 932. For example, this embodiment would be useful when an inventor generates a new electronic IDS 932 on remote server 930 at the beginning of the patent process. Later, an in-house attorney located at another location (e.g. corporate headquarters) may access and contribute to the electronic IDS 932. Then, even later in the patent process, an outside attorney in yet another location (e.g. a law firm) may access and contribute to the electronic IDS 932, for example.

FIG. 10 is a simplified diagram of an example of a hardware system according to another embodiment of the present invention. The embodiment of FIG. 10 includes a first local network 1010 having multiple client systems 1011, 1012, and 1013. Client systems 1011-1013 may access an intellectual property (“IP”) service provider web site 1040 through the local network 1010 and internet 1030. A second local network 1020 also having multiple clients 1021, 1022, and 1023 provides access to the IP service provider 1040 through internet 1030.

IP service provider web site 1040 includes a database 1041, an IDS generation program 1042, and a search engine 1043. IP service provider may be a web site that allows customers to manage and manipulate intellectual property information remotely. For example, in one embodiment, customers of an IP service provider may be allowed to remotely access search engine 1043. A user may access search engine 1043 for the purpose of conducting research into a particular field of technology. Using search engine 1043, a user may access electronic versions of technical documents stored in database 1041. Alternatively, a user might access electronic versions of technical documents located at web sites 1050 or 1060 in databases 1051 or 1061 respectively. In one embodiment, IDS generation program 1042 is running in the background, and when the user discovers an electronic document that is relevant to a future or pending patent application, the user may signal the IDS generation program to enter the document in an electronic IDS.

In another embodiment, IDS generation program 1042 on IP service provider web site 1040 may provide a user with information on when it is necessary to file an IDS. For example, if a user is conducting research using search engine 1043 and discovers a document that may be relevant, the user can signal IDS generation program to provide instructions on when it is necessary to file an IDS. IDS generation program 1042 may provide a help window with text illustrating the rules for filing an IDS. Alternatively, IDS generation program 1042 may provide the user with a series of questions designed to guide the user through the process of determining if the particular document must be disclosed to a patent office. Ultimately, the IDS generation program may provide the user with a menu selection or electronic button allows the user to signal the IDS program to extract IDS information from the document and store the IDS information in an electronic IDS.

In yet another embodiment, the first local network corresponds to a corporate client of the IP service provider web site 1042 and the second local network to a law firm. The law firm may prepare and a patent application for the corporate client and use the services of the IP service provider to file the patent application. In that case, when the patent application is filed, either manually or electronically, a signal is sent to IDS generation program 1042 indicating that an IDS is to be submitted. In response to the signal, IDS generation program may automatically retrieve an electronic IDS from database 1041 and file the electronic IDS with the patent application. In another embodiment, the IDS generation program automatically searches the database 1041, first local network 1010, and second local network 1020 for any electronic IDS associated with the patent application to be file. The IDS generation program may then cause multiple electronic IDS from multiple locations to be filed in the patent office with the patent application.

In another embodiment of the present invention, the IDS generation program includes additional code for automatically generating a letter to third parties in other countries when an IDS is filed in one country. For example, if an electronic IDS is filed in the USPTO at the time of filing a patent application on a particular invention, IDS generation program may generate a letter to lawyers in other countries where the invention is to be filed to inform them of what references were cited in the USPTO patent case. Alternatively, the IDS generation program may generate an email indicating that an IDS has been submitted and what references were in the IDS. For example, in one embodiment, the IDS generation program may generate an email to the U.S. lawyer indicating that an IDS has been submitted in another non-U.S. case and indicate the references cited in the case. The IDS generation program may then allow the user to select any or all of such references to be saved to an electronic IDS for the U.S. or non-U.S. case, as appropriate. The IDS generation program preferably performs an automatic check of any references already cited in electronic IDS documents in the case and notifies the user to allow deletion of any duplicates. The IDS program may also be written to identify a foreign patent office search report received or uploaded electronically in connection with a particular case and notify the user of such receipt. The program may then automatically check any electronic IDS documents for the corresponding U.S. case and notify the user of any references not yet cited. The user may then select any such references to be included in a new electronic IDS for the U.S. case in the manner described above.

These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

What is claimed is:

1. A computer-implemented method of generating an information disclosure statement comprising:
(a) receiving a signal indicating that a user has identified an electronic document that contains reference information to be disclosed to a patent office, the reference information including IDS information; and
(b) associating the IDS information with an electronic information disclosure statement.

2. The method of claim 1 wherein associating includes storing the IDS information in the electronic information disclosure statement.

3. The method of claim 1 wherein associating includes storing a plurality of pointers in the electronic information disclosure statement, and wherein each pointer corresponds to an electronic document.

4. The method of claim 3 further comprising:
receiving a second signal indicating that a patent application corresponding to the electronic information disclosure statement is being electronically filed in a patent office;
extracting the IDS information from each electronic document corresponding to the plurality of pointers; and
transmitting the IDS information from each electronic document corresponding to the plurality of pointers to the patent office.

5. The method of claim 1 further comprising extracting IDS information from the reference information.

6. The method of claim 5 wherein the IDS information is extracted from the reference information automatically in response to the signal.

7 The method of claim 1 further comprising providing a prompt to the user for generating the signal.

8. The method of claim 7 wherein the prompt comprises a field in a mouse pop-up window.

9. The method of claim 7 wherein the prompt comprises an electronic button.

10. The method of claim 7 wherein the prompt comprises a computer screen icon.

11. The method of claim 1 wherein the electronic document is downloaded from a database coupled to a computer network.

12. The method of claim 1 further comprising saving the electronic information disclosure statement in a database.

13. The method of claim 12 wherein the database is a local database coupled to a local computer network.

14. The method of claim 12 wherein the database is a remote database coupled to the internet.

15. The method of claim 1 further comprising providing access to the electronic information disclosure statement to multiple users over a network.

16. The method of claim 15 further comprising prompting the user for an access code when the user requests access to the electronic information disclosure statement, wherein when the correct code is provided by the user, the user may access the electronic information disclosure statement, and when the correct code is not provided by the user, the user may not access the electronic information disclosure statement.

17. The method of claim 1 further comprising providing the user with instructions on when an electronic document is to be disclosed to a patent office.

18. The method of claim 1 further comprising electronically transmitting the electronic information disclosure statement to a patent office.

19. The method of claim 1 further comprising:
receiving a second signal indicating that a patent application corresponding to the electronic information disclosure statement is being electronically filed in a patent office; and
electronically transmitting the electronic information disclosure statement to the patent office contemporaneously with the patent application.

20. The method of claim 1 further comprising automatically generating a letter to third party in a foreign country when the electronic information disclosure statement is filed in a patent office, the letter including a portion of the IDS information in the electronic information disclosure statement.

21. The method of claim 1 wherein the electronic document is an electronic version of a United States Patent.

22. The method of claim 1 wherein the electronic document is an electronic version of a foreign patent document.

23. The method of claim 1 wherein the electronic document is an electronic version of a publication.

24. A computer system comprising:
(a) a computer processor;
(b) a computer-readable memory, coupled to said computer processor, said computer-readable memory including computer instructions to:
(i) receive a signal indicating that a user has identified an electronic document that contains reference information to be disclosed to a patent office, the reference information including IDS information; and
(ii) associate the IDS information with an electronic information disclosure statement.

25. The computer system of claim 24 wherein the computer instruction to associate includes instructions to store the IDS information in the electronic information disclosure statement.

26. The computer system of claim 24 wherein the computer instruction to associate includes instructions to store a plurality of pointers in the electronic information disclosure statement, and wherein each pointer corresponds to an electronic document.

27. The computer system of claim 24 wherein said computer-readable memory further includes computer instructions to extract the IDS information from the reference information.

28. The computer system of claim 27 wherein the IDS information is extracted automatically with one mouse-click.

29. The computer system of claim 27 wherein the IDS information is extracted automatically by parsing the reference information.

30. The computer system of claim 27 wherein the IDS information is extracted using a pop-up menu system.

31. The computer system of claim 24 wherein said computer-readable memory further includes computer instructions to provide a prompt to the user for generating the signal.

32. The computer system of claim 24 wherein said computer-readable memory further includes computer instructions to save the electronic information disclosure statement in a database.

33. The computer system of claim 24 wherein said computer-readable memory further includes computer instructions to provide access to the electronic information disclosure statement to multiple users over a network.
